(19) United States
(12) Patent Application Publication
(10) Pub. No.: US 2008/0313317 A1
(43) Pub. Date: Dec. 18, 2008

(54) Network Management Using Peer-to-Peer Protocol

(76) Inventors: Michael Berger, Germering (DE); Steffen Rusitschka, Munchen (DE); Henning Sanneck, Munchen (DE); Joachim Sokol, Unterhaching (DE); Alan Southall, Munchen (DE)

Correspondence Address: STAAS & HALSEY LLP, SUITE 700, 1201 NEW YORK AVENUE, N.W., WASHINGTON, DC, 20005, US

(21) Appl. No.: 11/658,599

(22) PCT Filed: Jul. 11, 2005
(86) PCT No.: PCT/EP05/53305

§ 371 Date: Jan. 26, 2007

(30) Foreign Application Priority Data
Jul. 26, 2004 (DE) 10 2004 036 259.9

(51) Int. Cl. G06F 15/173

(52) U.S. Cl. 709/223

(57) ABSTRACT

A method operates a network management system comprising nodes which are used as manager and/or agent nodes. At least one node communicates with at least one other node using a peer-to-peer protocol. A network management system and a node in a management network system are used to carry out said method.

### CROSS REFERENCE TO RELATED APPLICATIONS

This application is based on and hereby claims priority to Application No. PCT/EP2005/053305 filed on Jul. 11, 2005 and German Application No. 10 2004 036 259.9 filed on Jul. 26, 2004, the contents of which are hereby incorporated by reference.

### BACKGROUND

The invention relates to a method for the operation of a network management system comprising nodes which are used as manager and/or agent nodes. Furthermore, the invention relates to a network management system and a node in a network management system.

To enable the efficient operation of networks, network management systems are employed which can take over the tasks of Fault Management, Configuration Management, Security Management, Accounting Management, and Performance Management, for example. The network management is intended to provide suitable mechanisms for information distribution and administration, with the result that the network operator is provided with the most comprehensive possible picture of the status of the network as and when required and the individual network nodes can be monitored and configured efficiently. For this purpose, management information is collected, stored and administered, by using information models, with the aid of databases. The collected data is evaluated as and when required by a manager that communicates with the agents dependent on said manager, which agents are located on the network nodes. In this respect, the network management is effected in separate processes according to sections of the network, so-called managed domains, to which the respective network management systems are assigned.

FIG. 1 shows two network management systems or the network sections MD1 and MD2 assigned to them. The network management systems display a database DB in each case which the manager M can access. A plurality of agents A is assigned to the managers in each case. For the purposes of communication between a manager M and the agents A in the context of the network management, various network management protocols can be employed, such as SNMP (Simple Network Management Protocol), CMIP (Common Management Information Protocol), CORBA (Common Object Request Broker Architecture), and Q3, for example.

Present-day network management systems use a fixed assignment of roles for the network nodes, and also fixed network management protocols and information models. Thus, for example, no communication can be effected between the various agents of a network management system, but just between a manager and the agents assigned to it, and this only by using the network management protocol defined for the purpose.

The document EP 0 682 429 A2 describes a method for the operation of a network management system by using SNMPv1. The agents and managers of the system are used as peers and have the same importance among themselves.

### SUMMARY

One potential object underlying the invention is to disclose a more flexible method for the operation of a network management system. Furthermore, the intention is to present a more flexible network management system and a node for such a network management system.

In the method for the operation of a network management system comprising nodes which are used as manager and/or agent nodes, the inventors propose that at least one node communicates with at least one other node by using a peer-to-peer protocol.

The network management system carries out tasks of network management such as Fault Management and/or Configuration Management and/or Security Management and/or Accounting Management and/or and Performance Management. It includes nodes that are used either exclusively as manager or agent nodes with reference to the network management, or can even take over both roles at the same time or one after the other. A manager prescribes management operations for agents to perform and evaluates the corresponding feedback, therefore controlling the respective agents. An agent processes the management operations that it has to perform and applies said management operations with reference to the objects to be managed. Messages are generated on the basis of said application of management operations that are sent to the manager. A description of the roles of the manager and the agent can be found in the standard document ISO 10040, for example. Nodes of a network management system can fulfill other functions outside the network management.

In a mobile communication system, the role of an agent can be performed, with reference to the radio access network as a managed domain, for example by a base station or, as the case may be, NodeB or by an RNC (Radio Network Controller). The role of a manager is normally exercised by a node that only performs said role and does not fulfill any other tasks with reference to the radio access network. Another managed domain of a mobile communication system normally comprises the core network.

Nodes communicate in the context of the network management by using a peer-to-peer protocol. Examples of particularly suitable peer-to-peer protocols for this purpose comprise:

Chord, e.g. described in I. Stoica et al., “Chord. A Scalable Peer-to-peer Lookup Protocol for Internet Applications”, ACM SIGCOMM, San Diego, Calif., USA, August 2001;

ZIGZAG, e.g. described in D. A. Tran et al., “ZIGZAG: An Efficient Peer-to-Peer Scheme for Media Streaming”, IEEE INFOCOM 2003;

Scribe, e.g. described in M. Castro et al., “SCRIBE: A large-scale and decentralized application-level multicast infrastructure”, IEEE JSAC, 2002;

CAN, e.g. described in S. Ratnasamy et al., “A Scalable Content-Addressable Network”, ACM Sigcomm 2001, San Diego, Calif.;

PAST, e.g. described in P. Druschel et al., “PAST: A large-scale, persistent peer-to-peer storage utility”, Hot OS VIII, Schloss Elmau, Germany, May 2001.

In general, peer-to-peer protocols that are based on DHTs (Distribution Hash Tables) in particular are suited to being employed with the method.

Peer-to-peer protocols give instructions for storing data in memories and for finding data in the appropriate memory or memories in each case. A peer-to-peer protocol therefore makes it possible for a peer, i.e. a node communicating with other nodes by using the peer-to-peer protocol, to find other peers, a naming space specific to the respective peer-to-peer protocol being used for addressing the peers. Furthermore, it is made possible for a peer to find data stored by other peers in an efficient manner.

With the proposed method and system, peer-to-peer communication can be effected between managers, between agents, and also between managers and agents. An advantageous aspect is the use of peer-to-peer protocols for communication between nodes of a network management system, in particular in the presence of a large number of agents, since the data interrogation of agents by a peer-to-peer protocol can be effected more quickly and more efficiently, i.e. by using a smaller quantity of messages between the nodes, by comparison with traditional methods. Even in the event that the data made available by the agents changes rapidly, the data interrogation by using peer-to-peer protocols proves to be advantageous with respect to traditional methods, since a peer-to-peer protocol is capable of informing a manager more efficiently about the change to the data.

In a development, all the nodes of the network management system use a peer-to-peer protocol for communicating among themselves. In particular, all the nodes can employ the same peer-to-peer protocol. It is also possible, however, for different nodes to use different peer-to-peer protocols, or for a plurality of peer-to-peer protocols to be utilized by all or some nodes.

According to an advantageous embodiment, said at least one node is used at times as a manager and at times as an agent. Additionally or alternatively, it is possible for said at least one node to be used as a manager with reference to one part of the network management and as an agent with reference to another part of the network management. In this respect, a part of the network management can comprise a specific task, a specific function or one or more specific elements of the network management, for example.

It is advantageous if said at least one node accesses a database distributed over a plurality of nodes for the purposes of network management. This means that a plurality of nodes or even all the nodes of the network management system display a memory, the overall content of the memories representing the database. It is possible in this respect for a plurality of nodes to display a common memory. It is advantageous in particular if no central database exists but instead only the database distributed over the memories of a plurality of nodes. Preferably, all the nodes of the network management system can access the distributed database by using a peer-to-peer protocol.

In a development, said at least one node communicates with at least one node of another network management system by using a peer-to-peer protocol. This results in a linking of a plurality of network management systems, with the result that data of one network management system can be accessed by another network management system or commands can go out to the other network management system. This is favorable in particular where reciprocal interactions are present between the various network management systems. An example of different network management systems comprises network management systems belonging to different radio access networks or radio access networks with different radio access technology (RAT), such as a network management system of a GSM (Global System for Mobile Communication) and a UMTS (Universal Mobile Telecommunications System) radio communication system, for example. The communication of various network management systems among themselves is advantageous particularly in the case of a dynamic network coupling, such as in the event, for example, that a network infrastructure of a radio network in aircraft, ships or trains is to be coupled to another radio network or decoupled from said other radio network. Furthermore, the flexibility of network management systems is supported where the changed or new structuring of a network management system is enabled by a communication of nodes of various network management systems.

In an embodiment, said at least one node communicates by using various network management protocols. Additionally or alternatively, it is possible for said at least one node to communicate by using various peer-to-peer protocols. In this respect, a first peer-to-peer protocol and/or network management protocol can be used at times, and another at other times, for example. It is also possible for a peer-to-peer protocol and/or network management protocol to be employed with reference to certain nodes as communication partners and/or tasks or functions of the network management, while another peer-to-peer protocol and/or network management protocol is employed with reference to other nodes as communication partners and/or tasks or functions of the network management.

It is particularly advantageous if a layer model is implemented on said at least one node, in which; a first layer is present with functions specific to at least one peer-to-peer protocol, a second layer is present with network management-specific functions, a third layer is present with both functions specific to at least one peer-to-peer protocol and also network management-specific functions.

The node in a network management system, which node is used as a manager and/or as an agent, has a communication unit to communicate with at least one other node which is used as a manager and/or as an agent, by using a peer-to-peer protocol.

In the network management system comprising nodes which are used as manager and/or agent nodes, at least a part of the nodes have a communication unit to communicate with other nodes by using a peer-to-peer protocol.

In an embodiment, the quantity of nodes which are used as manager nodes and/or nodes which are used as agent nodes at one time is variable.

Both the node in a network management system and also the network management system are particularly suitable for carrying out the method according to the invention, this also applying to the embodiments and developments.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1: two network management systems according to the related art,

FIG. 2: a network management system according to one potential embodiment of the invention,

FIG. 3: a layer model of a node for the purposes of implementing one potential embodiment of the invention.

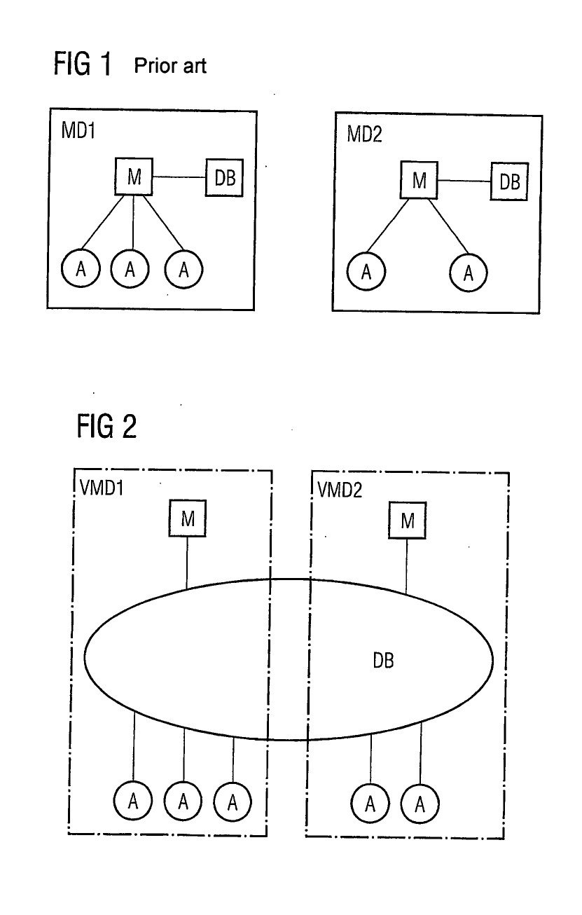

The related art represented in FIG. 1 has already been examined above.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

FIG. 2 shows a network management system having two managers M and five agents A. The nodes M and A of the network management system communicate among themselves by using a peer-to-peer protocol. No central database exists in which data is stored and retrieved by the managers. Instead, data is present on each node M and A of the network management system, which other nodes M and A can access by using the peer-to-peer protocol. The database DB of the network management system therefore includes the management information of the network management system present in the individual memories of the nodes M and A, indicated by an oval, which the nodes M and A of the network management system can access. A management information space is therefore opened out by the management information of the various memories of the nodes M and A of the network management system represented in FIG. 2, which appears to be a database DB to the nodes. The data items stored in the memories of the nodes M and A are normally different from each other; however, data can also be stored in a plurality of nodes M and A for the purposes of increasing redundancy and therefore security in the event of failure of a node M and A.

In principle, the use of the peer-to-peer protocol allows each node of the network management system to communicate with each other node and access its data. The strict separation between the role of a manager and that of an agent is therefore lifted. Thus, each node designated by A in FIG. 2 can retrieve data from firstly each other node designated by A and secondly each node designated by M and therefore be used as a manager with respect to each other node. Such an equality of the nodes of the network management system is enabled by the use of the peer-to-peer protocol. It is still possible, however, to restrict the authorizations of a node with the result that said node is allowed to be used just as an agent node either universally or only with reference to specific parts of the network management, for example. This corresponds to a restricted view of said node of the database DB. The authorizations can be defined centrally by the network operator prior to the initialization of the management information space.

Furthermore, parts of the network management system can be combined into virtual sub-network management systems VMD1 and VMD2 (VMD=Virtual Managed Domain). The virtual sub-network management systems VMD1 and VMD2 may involve the two network management systems separated in the traditional manner represented in FIG. 1, for example. Thus, with reference to specific parts of the network management which relate solely to one of the two virtual sub-network management systems VMD1 and VMD2 in each case, communication can take place just within the two virtual sub-network management systems VMD1 and VMD2. The communication within the two virtual sub-network management systems VMD1 and VMD2 is effected by using a peer-to-peer protocol. With regard to cross-system parts of the network management, such as, for example, a coupling or decoupling of the two virtual sub-network management systems VMD1 and VMD2 or an adaptation of configurations between the two virtual sub-network management systems VMD1 and VMD2, on the other hand, nodes of the first virtual sub-network management system VMD1 can communicate with nodes of the second virtual sub-network management system VMD2 by using a peer-to-peer protocol.

According to the related art, each manager has an overview of the status of its agents, while each agent only has a view of its own status. In the system shown in FIG. 2, however, it is possible for each manager to have both an overview of the status of each of its agents and also of the status of another manager belonging to another virtual sub-network management system, as well as of the status of the agents of the other manager. This is possible, depending on the rights granted, for each node of the network management system.

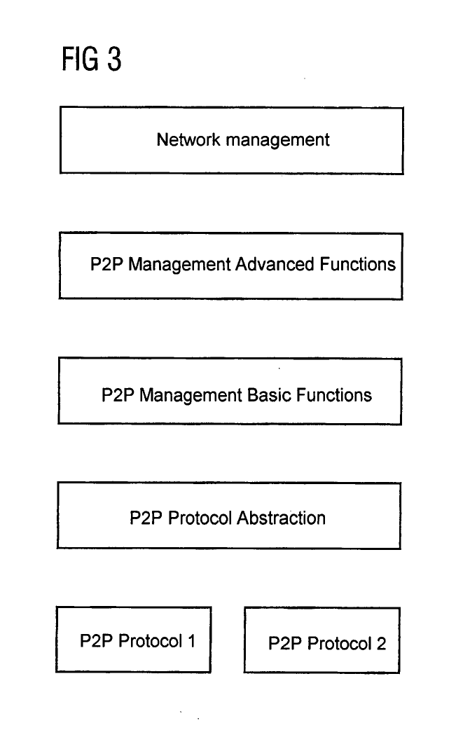

The method and system are not restricted to the use of a specific peer-to-peer protocol. Instead, various peer-to-peer protocols can be used for communicating between the nodes of a network management system. FIG. 3 shows the structure of a layer model which is implemented on the nodes of the network management system for the purposes of implementing the method. The peer-to-peer protocols are realized on the lowest layer, two peer-to-peer protocols, P2P PROTOCOL 1 and P2P PROTOCOL 2, being represented. The second-lowest layer, P2P PROTOCOL ABSTRACTION, is used for the abstraction of the concrete properties of the peer-to-peer protocols of the lowest layer, with the result that the employment of any desired peer-to-peer protocols is possible in principle. The lowest two layers are characterized by the embodiments of peer-to-peer protocols; they are independent of the network management. The top layer, GENERIC MANAGEMENT FUNCTIONS, on the other hand, is independent of the peer-to-peer protocols and is used for the implementation of the network management by using various network management protocols.

Between the two peer-to-peer-specific lowest layers and the top network management-specific layer are the two layers P2P MANAGEMENT BASIC FUNCTIONS and P2P MANAGEMENT ADVANCED FUNCTIONS which perform both peer-to-peer-specific and also network management-specific functions. These layers utilize the possibilities offered by peer-to-peer protocols for establishing the management information space. They take over the administration and provide suitable methods for manipulating the management information present in the management information space, and are responsible for the abstraction of the peer-to-peer protocols situated below.

The layer P2P MANAGEMENT BASIC FUNCTIONS performs the following functions:

Control and abstraction of the peer-to-peer protocols situated below,

Implementation of the bootstrapping, i.e. the finding of another peer,

Generation and administration of the management naming space, i.e. the representation of the individual nodes of the network management system,

Implementation of the security functions in order to ensure delimitation with respect to other peer-to-peer spaces and to implement and monitor control of the access rules to its own space,

Guaranteeing of the consistency of the data held in the network management system.

The layer P2P MANAGEMENT ADVANCED FUNCTIONS performs the following functions:

Representation of various network management information models in the management information space, implemented by the abstraction of various information models, of individual nodes, and their properties,

Implementation of the methods of access in the management information space to individual nodes and groups of nodes,

Implementation of processing methods for higher entities,

Implementation of any desired redundancy level for the information held in the management information space,

Implementation of the necessary filtering methods in order to enable distributed searching for management information,

Implementation of an automated take-over of functions by other nodes.

A series of advantages with respect to traditional network management systems is therefore achieved by the employment of the layer model represented in FIG. 3:

Abstraction of the information model used; any desired information models can now be applied in the network management system,

Abstraction of the network management protocol used; any desired network management protocols can now be applied in the network management system,

Dynamic allocation of constituents of the virtual sub-network management systems, as a function of the selected information model and network management protocol,

Cooperation between agents by the use of the peer-to-peer protocols, as a function of roles and rights of the information model used,

Simplified processing of network management data since any desired requests from nodes for data held in the management information space are possible,

More efficient administration of network management data since the logical view of the data held in the management information space is detached from the physical position of the individual nodes,

Automatic, scalably redundant distribution of network management information,

Dynamic assignment of roles to the nodes,

Distributed searching for network management information independently of the physical position of the individual nodes with the result that non-specific downloading of data from a plurality of nodes, in order to then search or filter it locally, can be avoided,

Scalability of the overall management information space,

High level of reliability and robustness of the network management system without costly infrastructure; higher failure-tolerance by distribution of functionalities to any desired nodes,

Support for self-organizing networks, such as ad hoc networks or movable network sections of a mobile communication system, for example.

The following concrete example considers a network management system having one manager and 100 agents which open out the management information space by their management information. The management information space can be established in such a way, for example, that an entity, i.e. a node of the network management system, is configured by an authorized person for the corresponding peer-to-peer protocols and information models. All further nodes receive knowledge of this “source entity”, it being possible to effect this in a wireless or wired manner. By way of negotiation algorithms with reference to the selection of the peer-to-peer protocols and information models to be used, new entities, i.e. nodes, can open out the information space with the “source entity”. The information model contains all the methods for manipulating management information within the management information space, and also the security functions for preserving the management information space. New nodes or groups of nodes can therefore immediately join the management information space or leave it.

The sequence of a distributed search of the manager is represented in detail. In this respect, a case is considered where the manager, in order to enable an optimum functioning of the network, must establish the node at which a specific counter, such as, for example, a counter for the quantity of forwarded packets of the node within a time interval, has exceeded a threshold value.

According to the related art, the manager would address all 100 agents direct for this purpose, by sending a corresponding request for the counter value. Those agents at which the counter displays a value or at which the counter is implemented send a reply. The manager fills a memory with the counter values received and checks with regard to each counter as to whether it is exceeding the threshold value.

In the case of a peer-to-peer protocol, the counter is mapped to a key value area of the peer-to-peer protocol and the request is sent by the manager to the management information space. Each agent carries out a check locally on the condition of whether the counter is exceeding the threshold value. Those agents at which the condition is applicable send a corresponding message to the manager by using the peer-to-peer protocol. Particularly in the case of a large quantity of agents, the sending of a large number of messages is therefore avoided by the use of a peer-to-peer protocol. The information needed is available to the manager more rapidly and the network management system is not blocked by a large number of messages sent between the manager and its agents.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for the operation of a network management system comprising nodes which are used as manager and/or agent nodes, comprising:
communicating between a first node and a second node using a peer-to-peer protocol; and
implementing a layer model on said first and second nodes, the layer model comprising:
a first layer having functions specific to at least one peer-to-peer protocol,
a second layer having network management-specific functions, and
a third layer having both peer-to-peer protocol functions and also network management-specific functions.

13. The method as claimed in claim 12, wherein all the nodes of the network management system use a peer-to-peer protocol for communicating among themselves.

14. The method as claimed in claim 12, wherein at least the first node is used at times as a manager and at times as an agent.

15. The method as claimed in claim 12, wherein at least the first node is used as a manager with reference to one part of the network management system and as an agent with reference to another part of the network management system.

16. The method as claimed in claim 14, wherein at least the first node accesses a database distributed over a plurality of nodes when the first node is used as a manager.

17. The method as claimed in claim 12, wherein at least the first node communicates with a node of another network management system using a peer-to-peer protocol.

18. The method as claimed in claim 12, wherein at least the first node communicates using a plurality of network management protocols.

19. The method as claimed in claim 12, wherein at least the first node communicates with a plurality of other nodes using a plurality of respective peer-to-peer protocols.

20. The method as claimed in claim 13, wherein at least the first node is used at times as a manager and at times as an agent.

21. The method as claimed in claim 20, wherein at least the first node is used as a manager with reference to one part of the network management system and as an agent with reference to another part of the network management system.

22. The method as claimed in claim 21, wherein at least the first node accesses a database distributed over a plurality of nodes when the first node is used as a manager.

23. The method as claimed in claim 22, wherein at least the first node communicates with a node of another network management system using a peer-to-peer protocol.

24. The method as claimed in claim 23, wherein at least the first node communicates using a plurality of network management protocols.

25. The method as claimed in claim 24, wherein at least the first node communicates with a plurality of other nodes using a plurality of respective peer-to-peer protocols.

26. A node in a network management system, which node is operable to function both as a network manager and as an agent, comprising:
a communication unit to communicate with at least one other node which is used as a manager and/or as an agent, using a peer-to-peer protocol, the communication unit operating using a layer model comprising:
a first layer having functions specific to at least one peer-to-peer protocol,
a second layer having network management-specific functions, and
a third layer having both one peer-to-peer protocol functions and also network management-specific functions.

27. A network management system comprising:
nodes which are used as manager and/or agent nodes, at least two the nodes each having a communication unit to communicate with other nodes using a peer-to-peer protocol, each communication unit using a layer model comprising:
a first layer having functions specific to at least one peer-to-peer protocol,
a second layer having network management-specific functions, and
a third layer having both one peer-to-peer protocol functions and also network management-specific functions.

28. The network management system as claimed in claim 27, wherein the network management system has a variation unit to vary the quantity of nodes which are used as manager nodes and/or vary the quantity of nodes which are used as agent nodes.
